(19) United States
(12) Patent Application Publication
(10) Pub. No.: US 2026/0006487 A1
(43) Pub. Date: Jan. 1, 2026

(54) COMMUNICATION METHOD AND COMMUNICATION APPARATUS

(71) Applicant: GUANGDONG OPPO MOBILE TELECOMMUNICATIONS CORP., LTD., Dongguan (CN)

(72) Inventors: Yali GUO, Dongguan (CN); Boren GUO, Dongguan (CN)

(73) Assignee: GUANGDONG OPPO MOBILE TELECOMMUNICATIONS CORP., LTD., Dongguan (CN)

(21) Appl. No.: 19/318,181

(22) Filed: Sep. 3, 2025

Related U.S. Application Data
(63) Continuation of application No. PCT/CN2023/084481, filed on Mar. 28, 2023.

(51) Int. Cl. H04W 28/02

(52) U.S. Cl. CPC H04W 28/0268

(57) ABSTRACT

A communication apparatus is provided. The communication apparatus includes a memory and a processor. The memory is configured to store a computer program, and the processor is configured to execute the computer program stored in the memory to cause the communication apparatus to perform an operation of: transmitting a first message to a first network element, wherein the first message comprises packet filtering information of a first data flow and/or first operation information for the first data flow.

### CROSS-REFERENCE TO RELATED APPLICATIONS

This application is a continuation of International Application No. PCT/CN2023/084481, filed on Mar. 28, 2023, the disclosure of which is hereby incorporated by reference in its entirety.

### TECHNICAL FIELD

This application relates to the field of communications technologies, and more specifically, to a communication method and a communications apparatus.

### BACKGROUND

In some communications systems, an operator network may provide a corresponding service (for example, data unit set-level processing, round-trip (RT) transmission control, or the like) for service data (for example, extended reality (XR), or the like). However, it is currently unclear how an operator network provides a corresponding service for service data.

### SUMMARY

Embodiments of this application provide a communication method and a communications apparatus. The following describes various aspects of embodiments of this application.

According to a first aspect, a communication method is provided, including: transmitting, by a terminal device, a first message to a first network element, where the first message includes packet filtering information of a first data flow and/or first operation information for the first data flow.

According to a second aspect, a communication method is provided, including: receiving, by a first network element, a first message transmitted by a terminal device, where the first message includes packet filtering information of a first data flow and/or first operation information for the first data flow.

According to a third aspect, a communication method is provided, including: receiving, by a second network element, a third message transmitted by a first network element, where the third message includes packet filtering information of a first data flow and/or first operation information for the first data flow.

According to a fourth aspect, a communications apparatus is provided, including: a transmitting unit, configured to transmit a first message to a first network element, where the first message includes packet filtering information of a first data flow and/or first operation information for the first data flow.

According to a fifth aspect, a communications apparatus is provided, including: a receiving unit, configured to receive a first message transmitted by a terminal device, where the first message includes packet filtering information of a first data flow and/or first operation information for the first data flow.

According to a sixth aspect, a communications apparatus is provided, including: a receiving unit, configured to receive a third message transmitted by a first network element, where the third message includes packet filtering information of a first data flow and/or first operation information for the first data flow.

According to a seventh aspect, a communications apparatus is provided, including a memory, a transceiver, and a processor, where the memory is configured to store a program, the processor performs data transmission and reception by using the transceiver, and the processor is configured to invoke the program in the memory to cause the communications apparatus to execute the method according to any one of the first aspect to the third aspect.

According to an eighth aspect, a communications apparatus is provided, including a processor, configured to invoke a program from a memory to cause the communications apparatus to execute the method according to any one of the first aspect to the third aspect.

According to a ninth aspect, a chip is provided, including a processor, configured to invoke a program from a memory to cause a device installed with the chip to execute the method according to any one of the first aspect to the third aspect.

According to a tenth aspect, a computer-readable storage medium is provided, storing a program, where the program causes a computer to execute the method according to any one of the first aspect to the third aspect.

According to an eleventh aspect, a computer program product is provided, including a program, where the program causes a computer to execute the method according to any one of the first aspect to the third aspect.

According to a twelfth aspect, a computer program is provided. The computer program causes a computer to execute the method according to any one of the first aspect to the third aspect.

### BRIEF DESCRIPTION OF DRAWINGS

FIG. 1 is an example diagram of a wireless communications system to which embodiments of this application are applied.

FIG. 2 is an example diagram of a 5G system architecture.

FIG. 3 is an example diagram of another 5G system architecture.

FIG. 4 is a schematic flowchart of a communication method according to an embodiment of this application.

FIG. 5 is a schematic structural diagram of a communications apparatus according to an embodiment of this application.

FIG. 6 is a schematic structural diagram of a communications apparatus according to another embodiment of this application.

FIG. 7 is a schematic structural diagram of a communications apparatus according to still another embodiment of this application.

FIG. 8 is a schematic structural diagram of an apparatus according to an embodiment of this application.

### DESCRIPTION OF EMBODIMENTS

Technical solutions in this application are described below with reference to the accompanying drawings.

FIG. 1 shows a wireless communications system 100 to which embodiments of this application are applied. The wireless communications system 100 may include a network device 110 and a user equipment (UE) 120. The network device 110 may communicate with the UE 120. The network device 110 may provide communication coverage for a specific geographical area, and may communicate with the UE 120 located within the coverage. The UE 120 may access a network (for example, a wireless network) by using the network device 110.

FIG. 1 exemplarily shows one network device and two UEs. Optionally, the wireless communications system 100 may include a plurality of network devices, and different quantities of terminal devices may be located in coverage of the network devices, which is not limited in embodiments of this application. Optionally, the wireless communications system 100 may further include another network entity such as a network controller or a mobility management entity, which is not limited in embodiments of this application.

It should be understood that technical solutions in the embodiments of this application may be applied to various communications systems, for example, a 5^{th} generation (5G) system or a new radio (NR) system, a long term evolution (LTE) system, an LTE frequency division duplex (FDD) system, and an LTE time division duplex (TDD) system. The technical solutions provided in this application may further be applied to a future communications system, such as a 6^{th} generation mobile communications system or a satellite communications system.

The UE in embodiments of this application may also be referred to as a terminal device, an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The UE in embodiments of this application may be a device providing a user with voice and/or data connectivity, and may be configured to connect people, objects, and machines. For example, the UE is a handheld device, a vehicle-mounted device, or the like having a wireless connection function. The UE in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, or the like. Optionally, the UE may be configured to function as a base station. For example, the UE may function as a scheduling entity, which provides a sidelink signal between UEs in V2X, D2D, or the like. For example, a cellular phone and a vehicle communicate with each other through a sidelink signal. A cellular phone and a smart home device communicate with each other, without relaying a communication signal through a base station.

The network device in embodiments of this application may be a device for communicating with the UE. The network device may also be referred to as an access network device or a radio access network device. For example, the network device may be a base station. The network device in embodiments of this application may be a radio access network (RAN) node (or device) that connects the UE to a wireless network. The base station may broadly cover various names in the following, or may be interchangeable with the following names, for example: a NodeB, an evolved NodeB (eNB), a next generation NodeB (gNB), a relay station, an access point, a transmitting and receiving point (TRP), a transmitting point (TP), a master eNodeB MeNB, a secondary eNodeB SeNB, a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof.

In some embodiments, the network device may be fixed or mobile. For example, a helicopter or an unmanned aerial vehicle may be configured to serve as a mobile network device, and one or more cells may move depending on a location of the mobile network device. In other examples, a helicopter or an unmanned aerial vehicle may be configured to serve as a device that communicates with another network device. In some embodiments, the network device may be a CU or a DU, or the network device may include a CU and a DU, or the network device may further include an AAU.

It should be understood that the network device may be deployed on land, including being deployed indoors or outdoors, or being handheld or vehicle-mounted, may be deployed on a water surface, or may be deployed on a plane, a balloon, or a satellite in the air. The network device and a scenario in which the network device is located in embodiments of this application are not limited in embodiments of this application.

It should also be understood that all or some of functions of the network device and the UE in this application may also be implemented by software functions running on hardware, or by virtualization functions instantiated on a platform (for example, a cloud platform).

This application is applicable to a mobile network, namely, a cellular network, and is described below by using a 5G network as an example. However, this application is not limited to the 5G network, and may also be used in a future mobile network, for example, a 6G network.

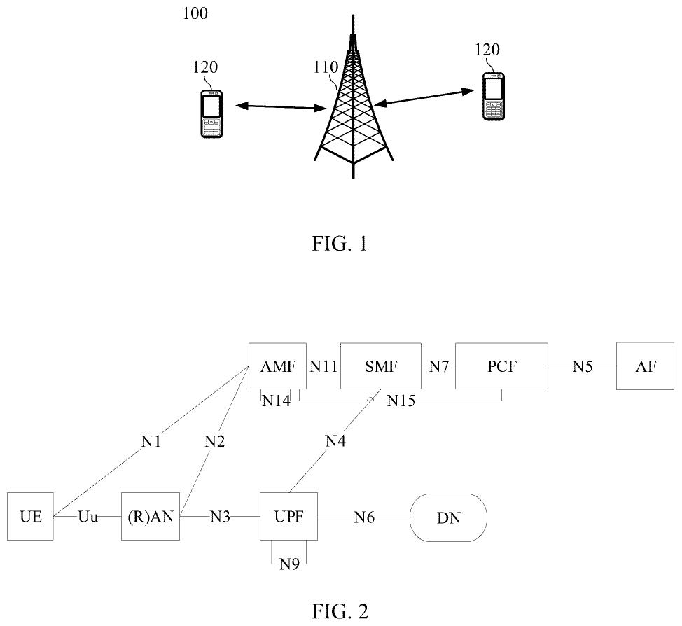

A system architecture of the 5G network may be as shown in FIG. 2 or 3, and includes an access and mobility management function (AMF), a session management function (SMF), a policy control function (PCF), an application function (AF), a UE, a radio access network (RAN) network element, a user plane function (UPF), a data network (DN), or another network element.

Core network elements shown in FIG. 2 may be connected to each other through agreed interfaces. Core network elements shown in FIG. 3 may interact with each other by invoking a service provided by these network elements. The interface mode between the network elements shown in FIG. 2 and the service invoking mode shown in FIG. 3 are not limited in this application.

As shown in FIG. 2 or 3, the UE may perform an access stratum connection to an AN, exchange an access stratum message with the AN, and transmit wireless data to the AN by using a Uu interface. The UE may perform a non-access stratum (NAS) connection to an AMF and exchange a NAS message with the AMF by using an N1 interface. The AMF is a mobility management function in a core network. The SMF is a session management function in the core network. In addition to performing mobility management on the UE, the AMF is also responsible for forwarding a message related to session management between the UE and the SMF. The PCF is a policy management function in the core network, and is responsible for formulating policies related to mobility management, session management, charging, and the like of the UE. The UPF is a user plane function in the core network, and performs data transmission with an external data network by using an N6 interface and performs data transmission with the AN by using an N3 interface. After accessing the 5G network by using the Uu interface, the UE may establish a PDU session for data transmission under control of the SMF.

The UE may establish a protocol data unit (PDU) session by using a 5G network element, and exchange data (application layer data) of a service with an application server (the AF shown in FIG. 2 or FIG. 3) or with a peer UE via the application server. For example, the service includes an extended reality (XR) service, including augmented reality (AR), virtual reality (VR), cloud gaming, or the like). Usually, the service data is application layer data subjected to specific encoding and compression. For example, after being encoded and compressed based on a common H.264 video codec technology standard and encapsulated in a format such as real-time transport protocol (RTP)/secure real-time transport protocol (SRTP), the application layer data is transmitted by using a PDU session of the UE.

Currently, the application server may request a PCF in a core network of an operator to parse the service data by a network. The PCF controls a network element of the core network to analyze RTP/SRTP packet header information, thereby determining a plurality of data packets that belong to one frame or coded slice. In the 5G network, these data packets may belong to one data unit set, such that the 5G network can perform consistent processing on a plurality of data packets that belong to one data unit set. For example, the 5G network performs quality of service (QOS) processing at a data unit set level, or discards transmission of remaining data packets in a data unit set if one data packet in the data unit set is lost. In addition, the application server may also request the PCF to perform round-trip (RT) transmission control for some services; and the PCF may dynamically adjust a QoS parameter of uplink or downlink data based on an actual transmission delay of the uplink or downlink data, thereby ensuring that a total delay of the uplink or downlink data meets a specific delay requirement.

However, currently, only the AF can request the network to provide a corresponding service for data of a service (for example, an XR service), such as processing at the data unit set level, RT transmission control, or the like. However, in actual deployment, some AFs cannot transmit these requests to the operator network because these AFs lack a direct interface with the operator network or do not have a service protocol signed with the operator network, or for other reasons. Therefore, when providing a service by using these AFs, the operator network cannot provide a corresponding service, which affects user experience.

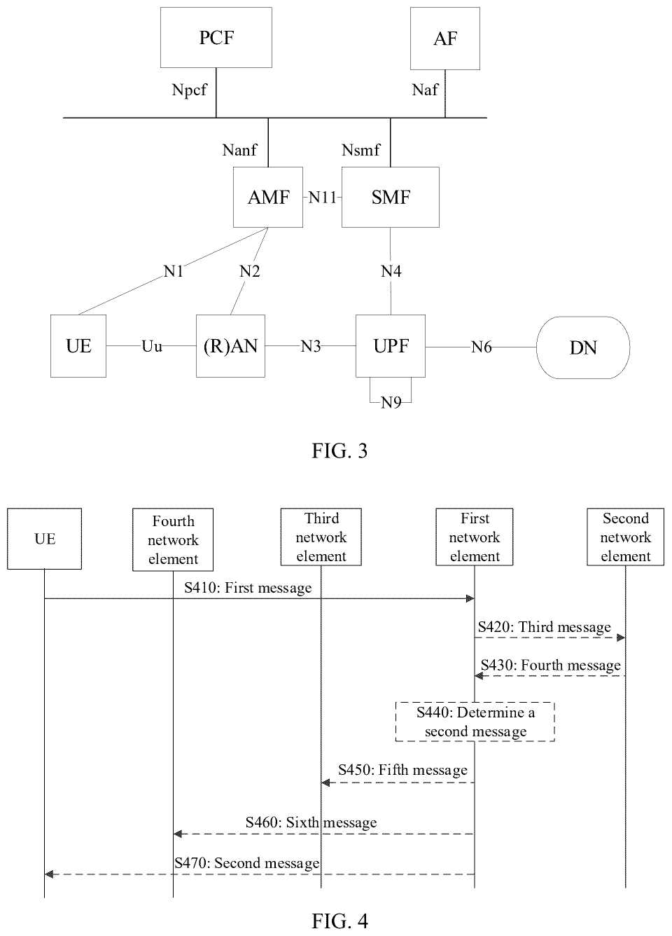

To resolve one or more of the foregoing technical problems, this application provides a communication method and a communications apparatus. The following describes in detail embodiments of this application with reference to FIG. 4.

FIG. 4 is a schematic flowchart of a communication method according to an embodiment of this application. The method 400 shown in FIG. 4 may include step S410. Details are as follows.

S410: A terminal device transmits a first message to a first network element.

The first message may include packet filtering information of a first data flow and/or first operation information for the first data flow. Optionally, the first message may be a PDU session modification request message or may be another message.

The first network element may be a session management network element, for example, an SMF.

The packet filtering information may be used to indicate a data flow (for example, the first data flow) corresponding to a requested service. For example, the packet filtering information may be an Internet protocol (IP) packet filter, an Ethernet packet filter, or the like. Optionally, the IP packet filter may include but is not limited to IP 5-tuple information, IP 3-tuple information, or the like.

The first operation information may include one or more of the following parameters: data unit set processing indication, data unit set QoS parameter, round-trip transmission control indication, round-trip transmission delay, data flow feature information, or data flow feature obtaining indication.

The data unit set processing indication may be used to indicate that the data flow is to be processed at a data unit set level; the data unit set QoS parameter may indicate a data unit set-level QoS parameter of the data flow; the round-trip transmission control indication may be used to indicate that round-trip transmission control is to be performed on the data flow; the round-trip transmission delay may indicate a round-trip transmission delay of the data flow; the data flow feature information may indicate a period of the data flow, a protocol description (for example, the protocol description may indicate that the data flow is transmitted by using transmission control protocol (TCP), RTP, SRTP, or that the data is encoded by using H.264, or the like), or the like; and the data flow feature obtaining indication may be used to indicate that the data flow is to be measured or detected, to obtain a feature value of the data flow, for example, obtain a jitter (jitter) value of the data flow, or the like.

In embodiments of this application, the first message includes the packet filtering information of the first data flow and/or the first operation information for the first data flow. The terminal device transmits the first message to the first network element, such that a network device may be requested to provide a corresponding service for the first data flow, thereby being beneficial for an operator network to provide the corresponding service for the first data flow.

In some embodiments, the first network element may transmit, to a second network element, the packet filtering information and/or the first operation information transmitted by the terminal device; and the second network element may perform processing based on the packet filtering information and/or the first operation information. For example, the method 400 may further include steps S420 and S430. Details are as follows.

S420: The first network element transmits a third message to a second network element.

The second network element may be a policy control network element, for example, a PCF.

Optionally, the third message may include the packet filtering information of the first data flow and/or the first operation information.

Optionally, after receiving the packet filtering information of the first data flow and/or the first operation information, the second network element may determine a fourth message based on the third message. For example, the second network element may determine a second message based on the third message and an operator policy.

Optionally, the fourth message may include feedback information of the first operation information.

Optionally, the feedback information of the first operation information may include one or more of the following:
permission for the first operation information, rejection of the first operation information, permission for one or more parameters in the first operation information, rejection of one or more parameters in the first operation information, or modification of one or more parameters in the first operation information.

For example, the second network element may permit or reject all parameters contained in the first operation information. Accordingly, the first operation information may include: permission for the first operation information or rejection of the first operation information. Alternatively, the second network element may permit or reject some of the parameters contained in the first operation information. Accordingly, the first operation information may include: permission for one or more parameters in the first operation information, or rejection of one or more parameters in the first operation information.

For another example, the second network element may modify one or more parameters (namely, some or all of the parameters) in the first operation information (for example, based on the first message). Accordingly, the first operation information may include: modification of one or more parameters in the first operation information.

For another example, the second network element may control transmission of the first data flow (for example, based on the first message). Accordingly, the first operation information may include: indication information for instructing the second network element to control transmission of the first data flow, and/or a control result of the first network element controlling transmission of the first data flow.

For example, the process of controlling, by the second network element, transmission of the first data flow may include: determining, by the second network element, QoS parameters of an uplink data flow and a downlink data flow based on the received round-trip transmission control indication and round-trip transmission delay, and adjusting the QoS parameters of the uplink data flow and the downlink data flow based on an actual transmission condition, such that a sum of transmission delays of the uplink data flow and the downlink data flow is within a specific range.

Optionally, after determining a fourth message, the second network element may transmit feedback information of the first operation information to the first network element. Specifically, the following step S430 may be performed.

S430: The second network element transmits a fourth message to the first network element.

Optionally, the fourth message may include feedback information of the first operation information.

In some embodiments, the method 400 may further include step S440. Details are as follows.

S440: The first network element determines a second message.

Optionally, the second message may include feedback information of the first operation information.

Optionally, the feedback information of the first operation information may include one or more of the following:
permission for the first operation information, rejection of the first operation information, permission for one or more parameters in the first operation information, rejection of one or more parameters in the first operation information, or modification of one or more parameters in the first operation information.

In some embodiments, the first network element may perform processing based on the first message transmitted by the terminal device. Optionally, the first network element may determine the second message based on the first message. For example, the first network element may determine the second message based on the first message and an operator policy. In this case, in the method 400, S420 and S430 may be performed before S440, or may not be performed.

For example, the first network element may permit or reject all parameters contained in the first operation information. Accordingly, the first operation information may include: permission for the first operation information or rejection of the first operation information. Alternatively, the first network element may permit or reject some of the parameters contained in the first operation information. Accordingly, the first operation information may include: permission for one or more parameters in the first operation information, or rejection of one or more parameters in the first operation information.

For another example, the first network element may modify one or more parameters (namely, some or all of the parameters) in the first operation information (for example, based on the first message), for example, modify a QoS parameter of the data unit set. Accordingly, the first operation information may include: modification of one or more parameters in the first operation information.

For another example, the first network element may control transmission of the first data flow (for example, based on the first message). Accordingly, the first operation information may include: indication information for instructing the first network element to control transmission of the first data flow, and/or a control result of the first network element controlling transmission of the first data flow.

For example, the process of controlling, by the first network element, transmission of the first data flow may include: determining, by the first network element, QoS parameters of an uplink data flow and a downlink data flow based on the received round-trip transmission control indication and round-trip transmission delay, and adjusting the QoS parameters of the uplink data flow and the downlink data flow based on an actual transmission condition, such that a sum of transmission delays of the uplink data flow and the downlink data flow is within a specific range.

In some embodiments, the first network element is not required to perform processing based on the first message transmitted by the terminal device, and is only required to determine the second message based on the fourth message transmitted by the second network element. In this case, in the method 400, S420 and S430 may be performed before S440.

Optionally, the first network element may directly determine the fourth message as the second message without modifying information included in the fourth message. In this case, the first network element transparently transmits, to the terminal device, the feedback information of the first operation information that is determined by the second network element. Alternatively, the first network element may modify the information included in the fourth message, and/or add new information and/or parameters to determine the second message. In this case, the first network element transmits modified (or processed) feedback information of the first operation information to the terminal device.

Optionally, the first network element may further determine a QoS flow used for transmitting the first data flow.

In some embodiments, after obtaining the feedback information of the first operation information according to the foregoing method (for example, S420 and S430, or S440), the first network element may transmit the feedback information of the first operation information to the terminal device. For example, the method 400 may further include step S470. Details are as follows.

S470: The first network element transmits the second message to the terminal device.

Optionally, the second message may include feedback information of the first operation information. Optionally, the second message may also include other information (content modified and/or added by the first network element, as shown in S440 described above). This is not limited in this application.

Further, the terminal device may control transmission of a data packet corresponding to the first data flow based on the second message. For example, the terminal device may control transmission of an uplink data packet (corresponding to the first data flow) based on the feedback information of the first operation information.

In some embodiments, the method 400 may further include step S450. Details are as follows.

S450: The first network element transmits a fifth message to a third network element.

Optionally, the third network element may be a user plane network element, for example, a UPF.

Optionally, the fifth message may include the packet filtering information of the first data flow, second operation information for the first data flow, and/or a QoS flow identifier (QFI) of a QoS flow corresponding to the first data flow.

Optionally, the second operation information may include one or more of the following parameters: data unit set processing indication, data flow feature information, or data flow feature obtaining indication.

The data unit set processing indication may be used to indicate that the data flow is to be processed at a data unit set level; the data flow feature information may indicate a period of the data flow, a protocol description (for example, the protocol description may indicate that the data flow is transmitted by using transmission control protocol (TCP), RTP, SRTP, or that the data is encoded by using H.264, or the like), or the like; and the data flow feature obtaining indication may be used to indicate that the data flow is to be measured or detected, to obtain a feature value of the data flow, for example, obtain a jitter value of the data flow, or the like.

Further, the third network element may match a downlink data packet based on the packet filtering information, add the QFI to a packet header of the data packet corresponding to the first data flow, and transmit the data packet to an access network device. The third network element may further perform the following operations on the data packet corresponding to the first data flow:

1. In a case that the data unit set processing indication is received, determining a data unit set to which a first data packet belongs, adding information about the data unit set to a header of the data packet, and transmitting the data packet to a fourth network element (for example, an access network device). Optionally, the protocol description may be used to assist the third network element in determining the information about the data unit set to which the first data packet belongs.

2. In a case that the data flow feature obtaining indication is received, measuring or detecting the first data flow to obtain a feature value of the data flow, for example, obtaining a jitter value of the first data flow and reporting the jitter value to the first network element.

In some embodiments, the method 400 may further include step S460. Details are as follows.

S460: The first network element transmits a sixth message to a fourth network element.

Optionally, the fourth network element may be an access network device, for example, a RAN in FIG. 2 or FIG. 3.

Optionally, the sixth message may include a QFI of a QoS flow corresponding to the first data flow and/or third operation information for the QoS flow.

Optionally, the third operation information may include one or more of the following parameters: data unit set processing indication, data unit set QoS parameter, round-trip transmission control indication, round-trip transmission delay, or data flow feature information.

The data unit set processing indication may be used to indicate that the data flow is to be processed at a data unit set level; the data unit set QoS parameter may indicate a data unit set-level QoS parameter of the data flow; the round-trip transmission control indication may be used to indicate that round-trip transmission control is to be performed on the data flow; the round-trip transmission delay may indicate a round-trip transmission delay of the data flow; the data flow feature information may indicate a period of the data flow, a protocol description (for example, the protocol description may indicate that the data flow is transmitted by using transmission control protocol (TCP), RTP, SRTP, or that the data is encoded by using H.264, or the like), or the like; and the data flow feature obtaining indication may be used to indicate that the data flow is to be measured or detected, to obtain a feature value of the data flow, for example, obtain a jitter value of the data flow, or the like.

Further, the fourth network element may perform resource scheduling on a QoS flow (for example, a QoS flow used for transmitting the first data flow) based on the third operation information. For example, the fourth network element may transmit a data packet of the QoS flow at the data unit set level, execute a data unit set-level QoS parameter, control a sum of transmission delays of uplink and downlink data to be within a specific range, and allocate radio resources based on information such as a period and jitter of the data flow.

It should be noted that S420, S430, S440, S450, S460, and S470 in FIG. 4 are all optional steps. The execution sequences of the steps in FIG. 4 are merely an example. Execution sequences of these steps are not limited in this application.

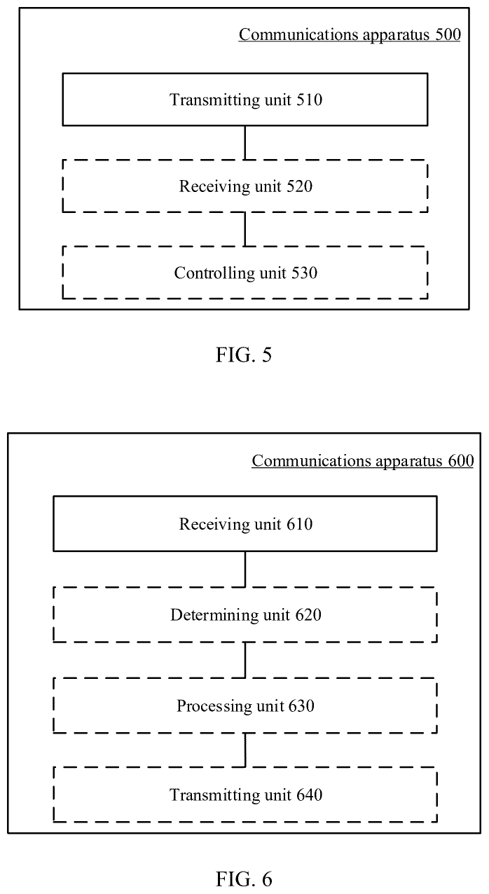

The method embodiments of this application are described above in detail with reference to FIG. 1 to FIG. 4. Apparatus embodiments of this application are described below in detail with reference to FIG. 5 to FIG. 8. It should be understood that the description of the method embodiments corresponds to the description of the apparatus embodiments, and therefore, for a part that is not described in detail, reference may be made to the foregoing method embodiments.

FIG. 5 is a schematic structural diagram of a communications apparatus according to an embodiment of this application. As shown in FIG. 5, the apparatus 500 includes a transmitting unit 510. Details are as follows.

The transmitting unit 510 is configured to transmit a first message to a first network element, where the first message includes packet filtering information of a first data flow and/or first operation information for the first data flow.

Optionally, the first operation information includes one or more of the following parameters: data unit set processing indication, data unit set quality of service QoS parameter, round-trip transmission control indication, round-trip transmission delay, data flow feature information, or data flow feature obtaining indication.

Optionally, the apparatus 500 further includes a receiving unit 520, configured to receive a second message transmitted by the first network element, where the second message includes feedback information of the first operation information.

Optionally, the feedback information of the first operation information includes one or more of the following: permission for the first operation information, rejection of the first operation information, permission for one or more parameters in the first operation information, rejection of one or more parameters in the first operation information, or modification of one or more parameters in the first operation information.

Optionally, the apparatus 500 further includes a controlling unit 530, configured to control transmission of a data packet corresponding to the first data flow based on the second message.

Optionally, the first message is a protocol data unit PDU session modification request message.

Optionally, the first network element is a session management function SMF.

FIG. 6 is a schematic structural diagram of a communications apparatus according to an embodiment of this application. The communications apparatus 600 in FIG. 6 includes a receiving unit 610. Details are as follows.

The receiving unit 610 is configured to receive a first message transmitted by a terminal device, where the first message includes packet filtering information of a first data flow and/or first operation information for the first data flow.

Optionally, the first operation information includes one or more of the following parameters: data unit set processing indication, data unit set quality of service QoS parameter, round-trip transmission control indication, round-trip transmission delay, data flow feature information, or data flow feature obtaining indication.

Optionally, the apparatus 600 further includes a determining unit 620, configured to determine a second message based on the first message, where the second message includes feedback information of the first operation information.

Optionally, the apparatus 600 further includes a processing unit 630, configured to modify one or more parameters in the first operation information based on the first message, and/or control transmission of the first data flow.

Optionally, the apparatus 600 further includes a transmitting unit 640, configured to transmit a third message to a second network element, where the third message includes the packet filtering information of the first data flow and/or the first operation information.

Optionally, the receiving unit 610 is further configured to receive a fourth message transmitted by the second network element, where the fourth message includes feedback information of the first operation information.

Optionally, the apparatus 600 further includes a transmitting unit 640, configured to transmit a second message to the terminal device, where the second message includes feedback information of the first operation information.

Optionally, the feedback information of the first operation information includes one or more of the following: permission for the first operation information, rejection of the first operation information, permission for one or more parameters in the first operation information, rejection of one or more parameters in the first operation information, or modification of one or more parameters in the first operation information.

Optionally, the apparatus 600 further includes a transmitting unit 640, configured to transmit a fifth message to a third network element, where the fifth message includes the packet filtering information of the first data flow, second operation information for the first data flow, and/or a QoS flow identifier QFI of a QoS flow corresponding to the first data flow.

Optionally, the second operation information includes one or more of the following parameters: data unit set processing indication, data flow feature information, or data flow feature obtaining indication.

Optionally, the third network element is a user plane function UPF.

Optionally, the apparatus 600 further includes a transmitting unit 640, configured to: transmit a sixth message to a fourth network element, where the sixth message includes a QoS flow identifier QFI of a QoS flow corresponding to the first data flow and/or third operation information for the QoS flow.

Optionally, the third operation information includes one or more of the following parameters: data unit set processing indication, data unit set quality of service QoS parameter, round-trip transmission control indication, round-trip transmission delay, or data flow feature information.

Optionally, the fourth network element is an access network device.

Optionally, the first message is a protocol data unit PDU session modification request message.

The apparatus is a session management function SMF.

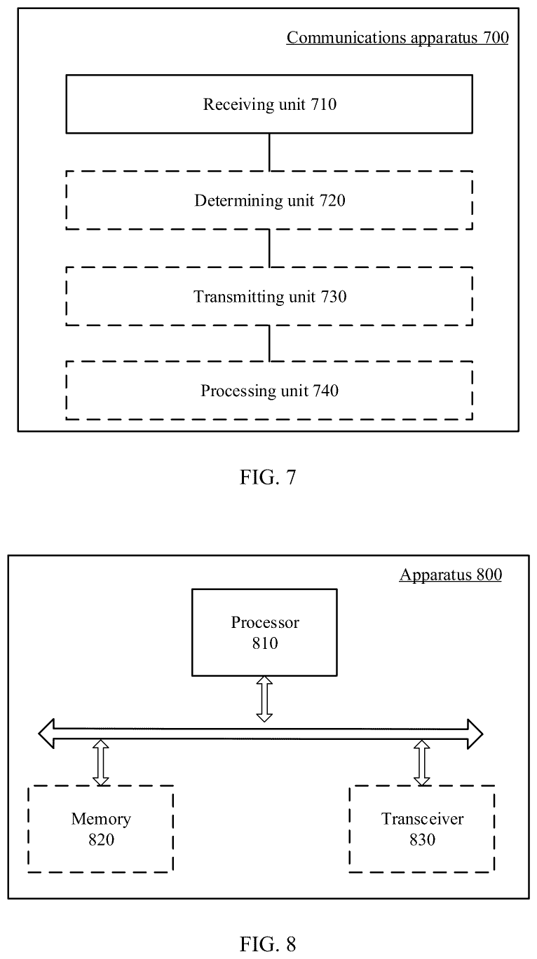

FIG. 7 is a schematic structural diagram of a communications apparatus according to an embodiment of this application. The communications apparatus 700 in FIG. 7 includes a receiving unit 710. Details are as follows.

The receiving unit 710 is configured to receive a third message transmitted by a first network element, where the third message includes packet filtering information of a first data flow and/or first operation information for the first data flow.

Optionally, the first operation information includes one or more of the following parameters: data unit set processing indication, data unit set quality of service QoS parameter, round-trip transmission control indication, round-trip transmission delay, data flow feature information, or data flow feature obtaining indication.

Optionally, the apparatus 700 further includes a determining unit 720, configured to determine a fourth message based on the third message, where the fourth message includes feedback information of the first operation information.

Optionally, the feedback information of the first operation information includes one or more of the following: permission for the first operation information, rejection of the first operation information, permission for one or more parameters in the first operation information, rejection of one or more parameters in the first operation information, or modification of one or more parameters in the first operation information.

Optionally, the apparatus 700 further includes a transmitting unit 730, configured to transmit the fourth message to the first network element.

Optionally, the apparatus 700 further includes a processing unit 740, configured to modify one or more parameters in the first operation information based on the third message, and/or control transmission of the first data flow.

Optionally, the first network element is a session management function SMF.

Optionally, the apparatus is a policy control function PCF.

FIG. 8 is a schematic structural diagram of an apparatus according to an embodiment of this application. Dashed lines in FIG. 8 indicate that the units or modules are optional. The apparatus 800 may be configured to implement a method described in the foregoing method embodiments. The apparatus 800 may be a chip or a communications apparatus.

The apparatus 800 may include one or more processors 810. The processor 810 may support the apparatus 800 in implementing a method described in the foregoing method embodiments. The processor 810 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 800 may further include one or more memories 820. The memory 820 stores a program, and the program may be executed by the processor 810, to cause the processor 810 to execute a method described in the foregoing method embodiments. The memory 820 may be separate from the processor 810 or may be integrated into the processor 810.

The apparatus 800 may further include a transceiver 830. The processor 810 may communicate with another device or chip by using the transceiver 830. For example, the processor 810 may transmit data to and receive data from another device or chip by using the transceiver 830.

An embodiment of this application further provides a computer-readable storage medium for storing a program. The computer-readable storage medium may be applied to the communications apparatus provided in embodiments of this application, and the program causes a computer to execute the methods executed by the communications apparatus in various embodiments of this application.

An embodiment of this application further provides a computer program product. The computer program product includes a program. The computer program product may be applied to the communications apparatus provided in embodiments of this application, and the program causes a computer to execute the methods executed by the communications apparatus in various embodiments of this application.

An embodiment of this application further provides a computer program. The computer program may be applied to the communications apparatus provided in embodiments of this application, and the computer program causes a computer to perform the method executed by the communications apparatus in various embodiments of this application.

It should be understood that, in embodiments of this application, “B corresponding to A” means that B is associated with A, and B may be determined based on A. However, it should be further understood that determining B based on A does not mean determining B based only on A, but instead, B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, in embodiments of this application, sequence numbers of the foregoing processes do not mean execution sequences. The execution sequences of the processes should be determined based on functions and internal logic of the processes, and should not be construed as any limitation on the implementation processes of embodiments of this application.

In several embodiments provided in this application, it should be understood that the disclosed system, apparatus, and method may be implemented in another manner. For example, the described apparatus embodiments are merely examples. For example, unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. Indirect couplings or communication connections between apparatuses or units may be implemented in electrical, mechanical, or other forms.

Units described as separate components may be or may not be physically separate, and components displayed as units may be or may not be physical units, that is, may be located in one position or may be distributed on a plurality of network units. Some or all of the units may be selected according to actual needs to achieve the objectives of solutions in embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) manner or a wireless (for example, infrared, wireless, or microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communications apparatus, comprising a memory and a processor, wherein the memory is configured to store a computer program, and the processor is configured to execute the computer program stored in the memory to cause the communication apparatus to perform an operation of:
transmitting a first message to a first network element, wherein the first message comprises packet filtering information of a first data flow and/or first operation information for the first data flow.

2. The apparatus according to claim 1, wherein the first operation information comprises one or more of following parameters:
data unit set processing indication, data unit set quality of service QoS parameter, round-trip transmission control indication, round-trip transmission delay, data flow feature information, or data flow feature obtaining indication.

3. The apparatus according to claim 1, wherein the apparatus is further configured to: receive a second message transmitted by the first network element, wherein the second message comprises feedback information of the first operation information.

4. The apparatus according to claim 3, wherein the feedback information of the first operation information comprises one or more of following:
permission for the first operation information, rejection of the first operation information, permission for one or more parameters in the first operation information, rejection of one or more parameters in the first operation information, or modification of one or more parameters in the first operation information.

5. The apparatus according to claim 3, wherein the apparatus is further configured to: control transmission of a data packet corresponding to the first data flow based on the second message.

6. The apparatus according to claim 1, wherein the first message is a protocol data unit PDU session modification request message.

7. The apparatus according to claim 1, wherein the first network element is a session management function SMF.

8. A communications apparatus, comprising a memory and a processor, wherein the memory is configured to store a computer program, and the processor is configured to execute the computer program stored in the memory to cause the communication apparatus to perform an operation of:
receiving a first message transmitted by a terminal device, wherein the first message comprises packet filtering information of a first data flow and/or first operation information for the first data flow.

9. The apparatus according to claim 8, wherein the first operation information comprises one or more of following parameters:
data unit set processing indication, data unit set quality of service QoS parameter, round-trip transmission control indication, round-trip transmission delay, data flow feature information, or data flow feature obtaining indication.

10. The apparatus according to claim 8, wherein the apparatus is further configured to determine a second message based on the first message, wherein the second message comprises feedback information of the first operation information.

11. The apparatus according to claim 8, wherein the apparatus is further configured to modify one or more parameters in the first operation information based on the first message, and/or control transmission of the first data flow.

12. The apparatus according to claim 8, wherein the apparatus is further configured to transmit a third message to a second network element, wherein the third message comprises the packet filtering information of the first data flow and/or the first operation information.

13. The apparatus according to claim 12, wherein the apparatus is further configured to receive a fourth message transmitted by the second network element, wherein the fourth message comprises feedback information of the first operation information.

14. The apparatus according to claim 8, wherein the apparatus is further configured to transmit a second message to the terminal device, wherein the second message comprises feedback information of the first operation information.

15. The apparatus according to claim 10, wherein the feedback information of the first operation information comprises one or more of following:
permission for the first operation information, rejection of the first operation information, permission for one or more parameters in the first operation information, rejection of one or more parameters in the first operation information, or modification of one or more parameters in the first operation information.

16. The apparatus according to claim 8, wherein the apparatus is further configured to transmit a fifth message to a third network element, wherein the fifth message comprises the packet filtering information of the first data flow, second operation information for the first data flow, and/or a QoS flow identifier QFI of a QoS flow corresponding to the first data flow.

17. The apparatus according to claim 16, wherein the second operation information comprises one or more of following parameters:
data unit set processing indication, data flow feature information, or data flow feature obtaining indication.

18. The apparatus according to claim 16, wherein the third network element is a user plane function UPF.

19. The apparatus according to claim 8, wherein the apparatus is further configured to:
transmit a sixth message to a fourth network element, wherein the sixth message comprises a QoS flow identifier QFI of a QoS flow corresponding to the first data flow and/or third operation information for the QoS flow.

20. The apparatus according to claim 19, wherein the third operation information comprises one or more of following parameters:
data unit set processing indication, data unit set quality of service QoS parameter, round-trip transmission control indication, round-trip transmission delay, or data flow feature information.
